(19) United States
(12) Patent Application Publication
(10) Pub. No.: US 2009/0154912 A1
(43) Pub. Date: Jun. 18, 2009

(54) Multi-axis dome camera

(75) Inventors: Jia-Nan Lin, Jhonghe City (TW); Mu-chung Kuo, Jhonghe City (TW)

Correspondence Address: BACON & THOMAS, PLLC, 625 SLATERS LANE, FOURTH FLOOR, ALEXANDRIA, VA, 22314-1176, US

(73) Assignee: YOKO Technology Corp., Jhonghe City (TW)

(21) Appl. No.: 12/000,580

(22) Filed: Dec. 14, 2007

(51) Int. Cl. G03B 17/00

(52) U.S. Cl. 396/427

(57) ABSTRACT

A multi-axis dome camera includes a base having a support bracket fixedly mounted thereon and a pivoted bracket pivotally connected to an upper end of the support bracket to be 180-degree vertically turnable relative to the latter; a rotating disc being connected to a top of the pivoted bracket to produce a right angle, so that the rotating disc is able to conduct directly on the pivoted bracket the adjustment of an angle by which a captured image is presented; and a camera lens mounted on the rotating disc to rotate along with the rotating disc. With the above arrangements, the camera lens may change in its vertical and horizontal positions to capture images presented in more different directions. The multi-axis dome camera requires fewer parts to enable reduced manufacturing cost and is therefore suitable for mass production.

### FIELD OF THE INVENTION

The present invention relates to a camera, and more particularly to a multi-axis dome camera.

### BACKGROUND OF THE INVENTION

Many dome cameras have been used as surveillance cameras to assist in protecting community safety. A large number of crimes and illegal events were discovered or otherwise prevented with the help of surveillance cameras. In view of the positive function of surveillance cameras in maintaining society and community safety, manufacturers of security system products all engage in the manufacture of newer, better, and more cost-effective surveillance cameras.

FIG. 1 shows a conventional dome camera that is frequently used as a surveillance camera. The conventional dome camera includes a base 10; a rotating table 12 rotatably mounted in the base 10 via an insertion pin 14; a first pair of support arms 121 are diametrically oppositely erected on the rotating table 12; a frame-like platform 16 fixedly connected at two opposite ends to upper ends of the two support arms 121 to be 180-degree horizontally turnable along with the rotating table 12; a second pair of support arms 161 upward extended from another two opposite ends of the frame-like platform 16; and a camera 18 pivotally connected to and between the two support arms 161. With these arrangements, the camera 18 may be turned horizontally and vertically in three axes, as shown in FIG. 2, so as to capture images in a wide area.

The above-structured conventional dome camera has the following disadvantages: (1) the assembly of the rotating table 12, the frame-like platform 16, and the camera 18 has a fixed height that prevents the dome camera from having a reduced overall volume for freely mounting to any desired places; and (2) the rotating table 12, the first support arms 121, the frame-like platform 16, and the second support arms 161 all require a lot of time and efforts to fabricate and tighten them in place, resulting in increased manufacturing cost of the dome camera.

It is therefore tried by the inventor to develop a multi-axis dome camera to overcome the drawbacks in the conventional surveillance cameras and dome cameras.

### SUMMARY OF THE INVENTION

A primary object of the present invention is to provide a multi-axis dome camera that enables a camera lens thereof to rotate in three dimensions in multi-axis movement, so that images presented in more different directions may be captured by the camera lens.

Another object of the present invention is to provide a multi-axis dome camera that has simplified structure and may be manufactured with fewer material and labor to reduce the manufacturing cost thereof while achieving a multi-axis rotating effect.

To achieve the above and other objects, the multi-axis dome camera according to the present invention includes a base having a support bracket fixedly mounted thereon and a pivoted bracket pivotally connected to an upper end of the support bracket to be 180-degree vertically turnable relative to the support bracket; a rotating disc being connected to a top of the pivoted bracket to produce a right angle, so that the rotating disc is able to conduct directly on the pivoted bracket the adjustment of an angle by which a captured image is presented; and a camera lens mounted on the rotating disc to rotate along with the rotating disc. With the above arrangements, the camera lens may change in its vertical and horizontal positions to capture images presented in more different directions.

The base, the support bracket, the pivoted bracket, and the rotating disc have simple structure and may be easily assembled to thereby effectively reduce the material, labor, and assembling costs of the dome camera, enabling the dome camera to be mass-produced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a conventional dome camera;

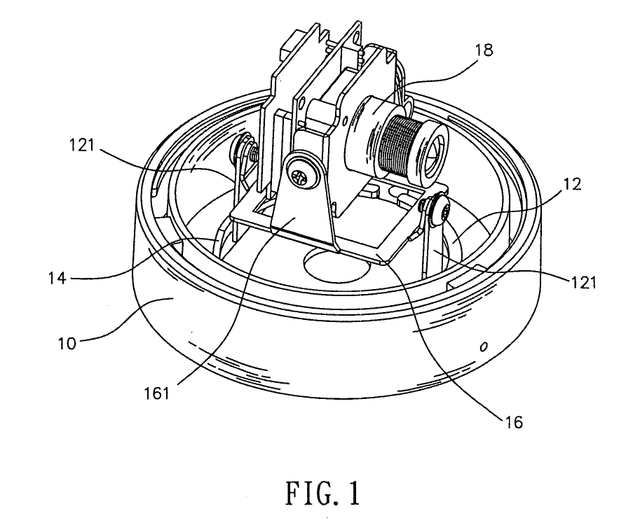

FIG. 2 shows a camera lens of the conventional dome camera is in an angularly turned position;

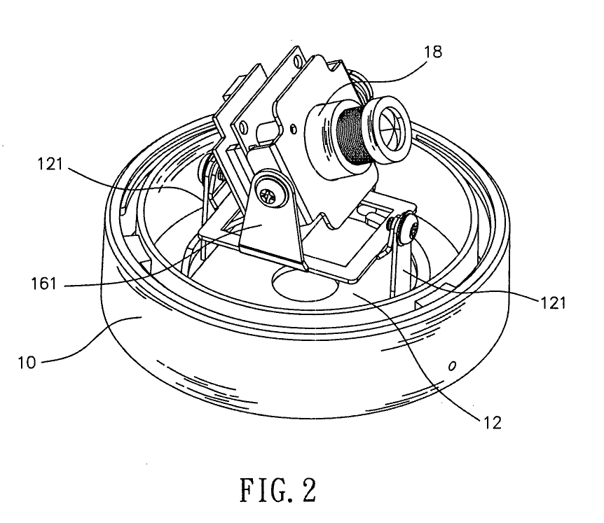

FIG. 3 is a perspective view of a multi-axis dome camera according to a preferred embodiment of the present invention;

FIG. 4 shows a pivoted bracket of the multi-axis dome camera of the present invention is 180-degree vertically turnable relative to a support bracket; and

FIG. 5 shows a rotating disc of the multi-axis dome camera of the present invention is horizontally turnable in multiple angles of rotation.

### DETAILED DESCRIPTION OF THE PREFERRED EMBODIMENTS

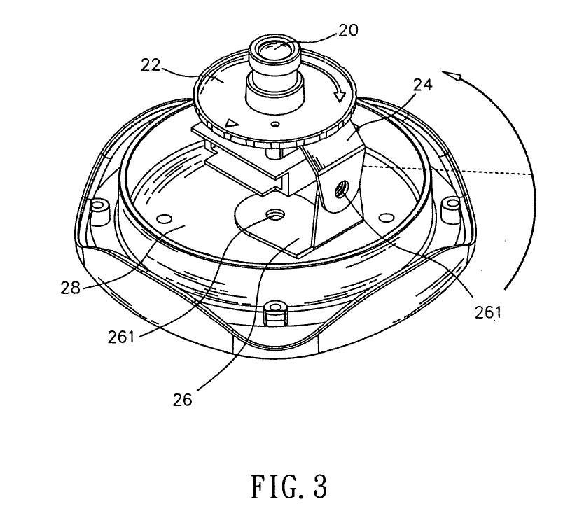

Please refer to FIG. 3 that is a perspective view of a multi-axis dome camera according to a preferred embodiment of the present invention. As shown, the multi-axis dome camera of the present invention includes a camera lens 20, a rotating disk 22, a pivoted bracket 24, and a support bracket 26. The support bracket 26 is fixedly mounted on a base 28 of the dome camera using a fastening element 261, which may be a screw, a rivet, or the like. The rotating disc 22 may be round or polygonal in shape. The rotating disc 22, the pivoted bracket 24, and the support bracket 26 may be made of a metal material or a plastic material. In addition, the rotating disc 22 may be a circuit board or may have the property of a circuit board.

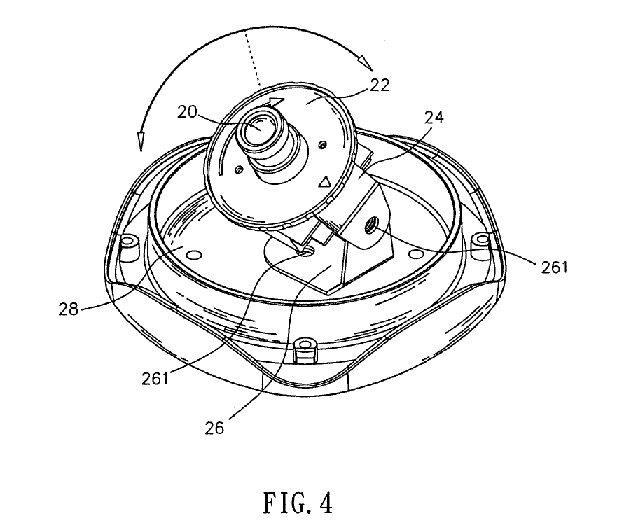

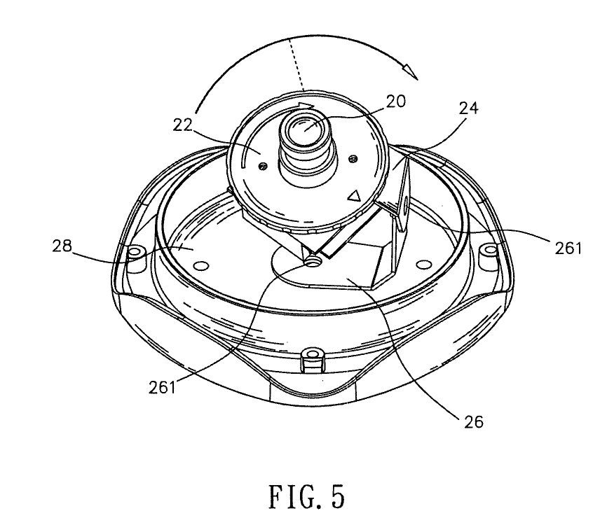

Please refer to FIG. 4 that shows the pivoted bracket 24 of the multi-axis dome camera of the present invention is 180-degree vertically turnable relative to the support bracket 26, and to FIG. 5 that shows the rotating disc 22 of the multi-axis dome camera of the present invention is horizontally turnable in multiple angles of rotation. As shown, the camera lens 20 may be a CCD (Charge-Coupled Device) lens or a CMOS (Complementary Metal-Oxide-Semiconductor) lens, and is fixedly mounted on the rotating disc 22, which is then connected to the pivoted bracket 24. Both the pivoted bracket 24 and the support bracket 26 may be L-shaped to have only one single arm each, or inverted U-shaped to have two parallel arms each, and the pivoted bracket 24 is pivotally turnably connected to an upper end of the support bracket 26 using another fastening element 261, so that the pivoted bracket 24 is 180-degree vertically turnable relative to the support bracket 26. When the 360-degree freely turnable rotating disc 22 cooperates with the 180-degree vertically turnable pivoted bracket 24, it is possible for the rotating disc 22 to change in multiple different angular positions. The multi-axis dome camera of the present invention only requires the pivoted bracket 24 and the support bracket 26, which cooperate with the rotating disc 22. When the rotating disc 22 is rotated, the camera lens 20 rotates along the rotating disc 22 to thereby achieve free adjustment of the direction in which the captured image is presented, and moves in multi-axis movement.

The conventional dome camera has complicated structure and accordingly, high manufacturing cost. Moreover, since the conventional dome camera is usually fixedly mounted to a ceiling for capturing images, software and/or hardware is needed for adjusting the output captured image, in order to turn the captured images by 90 degrees. Unlike the conventional dome camera, the multi-axis dome camera of the present invention has simplified structure to enable low manufacturing cost thereof, and the camera lens thereof is turnable directly on the camera base to conduct the adjustment of the direction of the captured images. Therefore, the dome camera is more easily operable, a user does not need to adjust the captured images at an output end, and the captured images can be more vividly presented.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A multi-axis dome camera, comprising:
a base having a support bracket fixedly mounted thereon, and a pivoted bracket pivotally connected to an upper end of the support bracket, such that the pivoted bracket is 180-degree vertically turnable relative to the support bracket;
a rotating disc being connected to a top of the pivoted bracket to produce a right angle, so that the rotating disc is able to freely rotate on the pivoted bracket in multiple angles of rotation; and
a camera lens being mounted on the rotating disc, such that when the rotating disc is rotated, the camera lens and the direction in which an image captured by the camera lens is presented are rotated at the same time.

2. The multi-axis dome camera as claimed in claim 1, wherein the support bracket is fixedly mounted on the base using at least one fastening element.

3. The multi-axis dome camera as claimed in claim 2, wherein the fastening element is a screw.

4. The multi-axis dome camera as claimed in claim 2, wherein the fastening element is selected from the group consisting of a rivet and an insertion pin.

5. The multi-axis dome camera as claimed in claim 1, wherein the camera lens is a CCD lens.

6. The multi-axis dome camera as claimed in claim 1, wherein the camera lens is a CMOS lens.

7. The multi-axis dome camera as claimed in claim 1, wherein the support bracket and the pivoted bracket cooperate with the rotating disc to enable the camera lens to change in its vertical and horizontal positions.

8. The multi-axis dome camera as claimed in claim 1, wherein the rotating disc is selected from the group consisting of a round disc, a polygonal disc, and other irregularly shaped discs.

9. The multi-axis dome camera as claimed in claim 1, wherein the rotating disc, the pivoted bracket, and the support bracket are made of a metal material.

10. The multi-axis dome camera as claimed in claim 1, wherein the rotating disc, the pivoted bracket, and the support bracket are made of a plastic material.

11. The multi-axis dome camera as claimed in claim 1, wherein the rotating disc is a circuit board or has the property of a circuit board.

12. The multi-axis dome camera as claimed in claim 1, wherein the support bracket and the pivoted bracket have a configuration selected from the group consisting of an L-shaped bracket having one single arm, and an inverted U-shaped bracket having two parallel arms.
